(19) United States
(12) Patent Application Publication
(10) Pub. No.: US 2007/0262952 A1
(43) Pub. Date: Nov. 15, 2007

(54) Mapping pointing device messages to media player functions

(75) Inventor: David M. Nadalin, Sammamish, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/433,469

(22) Filed: May 12, 2006

(51) Int. Cl. G09G 5/00; G09G 5/08

(52) U.S. Cl. 345/156; 345/163

(57) ABSTRACT

A media player application as described herein is configured to repurpose a general purpose pointing device, such as a mouse, for use as a remote controller for the media player application. Standard mouse messages are mapped to designated media player control functions, and such mapping enables the media player application to convert the standard mouse messages into corresponding media player control instructions. For example, a left click message may be mapped to a play function, a right click message may be mapped to a menu access function, and so on.

### BACKGROUND

Home computer systems are increasingly becoming an integral component for the playback of audio and/or video content in a home theater, stereo, or multimedia environment. For example, a personal computer can be utilized for the playback of movies stored on DVDs, video files, music stored on CDs, music files, and the like. In connection with such media content, the computer system should allow the user to control the playback of the content, much like a standalone DVD player or CD player.

One playback control solution utilizes a remote control device as typically provided with televisions, VCRs, DVD players, CD players, stereo receivers, and the like. This solution results in additional cost to the user, and may be undesirable to users seeking to reduce the number of remote controls and clutter in the computing and/or home theater environment. A more computer-centric solution utilizes an onscreen user interface that can be manipulated by the user in a familiar manner using a mouse, a keyboard, a touchpad, or other control device. Most users are familiar with such control devices in the context of routine computer operation. Reliance on a keyboard interface, however, can be problematic in a home theater environment because it can be difficult to see the keyboard in low light conditions. Moreover, the keyboard may be tethered to the computer system, thus requiring the user to be in close proximity to the computer system. In addition, certain keystroke sequences, such as “Control-P” for play, may not make sense in foreign languages. Likewise, the problem with using a conventional mouse in a home theater environment is that the mouse may be tethered to the computer system. Furthermore, conventional mice and other pointing devices require onscreen controls with which to interact, where such onscreen controls tend to overlap the view of the content window displayed on the computer monitor. In addition, a non-wireless mouse also requires a flat surface to support its movement.

One conventional computer mouse design utilizes additional mouse buttons that have designated functions that are specific to the media player application. For example, such a mouse might include a devoted play button, a devoted fast forward button, and a devoted rewind button in addition to the standard two-button or the standard four-button configuration. This type of hardware solution results in added expense to the user. Another computer mouse design includes a physical switch that selects either a mouse mode or a media mode. When the media mode is selected, the mouse generates media control signals (rather than standard mouse control signals) for transmission to the computer system. This hardware solution also results in added expense to the user.

### BRIEF SUMMARY

Technologies and techniques described herein relate to controlling the operation of a media player application by mapping pointing device messages to media player control functions. Techniques described herein may be performed in conjunction with the manipulation of a computer pointing device, such as a mouse, and such techniques can be supported with a general purpose and standard mouse, i.e., a conventional two-button or four-button mouse without any special modifications. In one embodiment, the technologies and techniques repurpose a pointing device when a media player application is placed into a full screen mode, such that standard pointing device messages are converted to control features of the media player application.

### BRIEF DESCRIPTION OF THE DRAWINGS

A more complete understanding of example embodiments may be derived by referring to the detailed description and claims when considered in conjunction with the following figures, wherein like reference numbers refer to similar elements throughout the figures.

FIG. 1 is a simplified schematic representation of an example computer system for implementing an example embodiment;

FIG. 2 is a simplified schematic representation of an example media player application for implementing an example embodiment;

FIG. 3 is a simplified rendition of a screen shot including a media player application running in a non-full-screen mode;

FIG. 4 is a simplified rendition of a screen shot including a media player application running in a full screen mode;

FIG. 5 is a table of example mapping of media player control functions to standard mouse messages; and

FIG. 6 is a flow diagram of a media player mouse control process corresponding to an example embodiment.

### DETAILED DESCRIPTION

The following detailed description is merely illustrative in nature and is not intended to limit the embodiments or the application and uses of such embodiments. Example embodiments may be described herein in terms of functional and/or logical block components and various processing steps. It should be appreciated that such block components may be realized by any number of hardware, software, and/or firmware components configured to perform the specified functions. For example, an embodiment may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments may be practiced in conjunction with any number of data transmission protocols and that the system described herein is merely one example embodiment.

For the sake of brevity, conventional techniques related to computer devices, media player applications, signal processing, data transmission, signaling, computer operating systems, network control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an example embodiment.

The following description may refer to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. Thus, although the figures may depict example arrangements of elements, additional intervening elements, devices, features, or components may be present in an example embodiment (assuming that the functionality of the system is not adversely affected).

Briefly, an example embodiment is directed to a method by which a media player application may remap the button configuration for a pointing device, such as a mouse, in response to a change in the operating mode of the media player application. In order to selectively control application behavior, the media player application monitors its application state and responds to certain state changes by capturing mouse input information from the operating system and remapping it in accordance with a mapping table (which may be user-configurable) maintained by the media player application. Media specific control functions may be temporarily mapped to standard mouse buttons and the mouse can be automatically repurposed for use in controlling media playback when the media player application enters full screen mode or in response to other operating conditions or characteristics as described in more detail below.

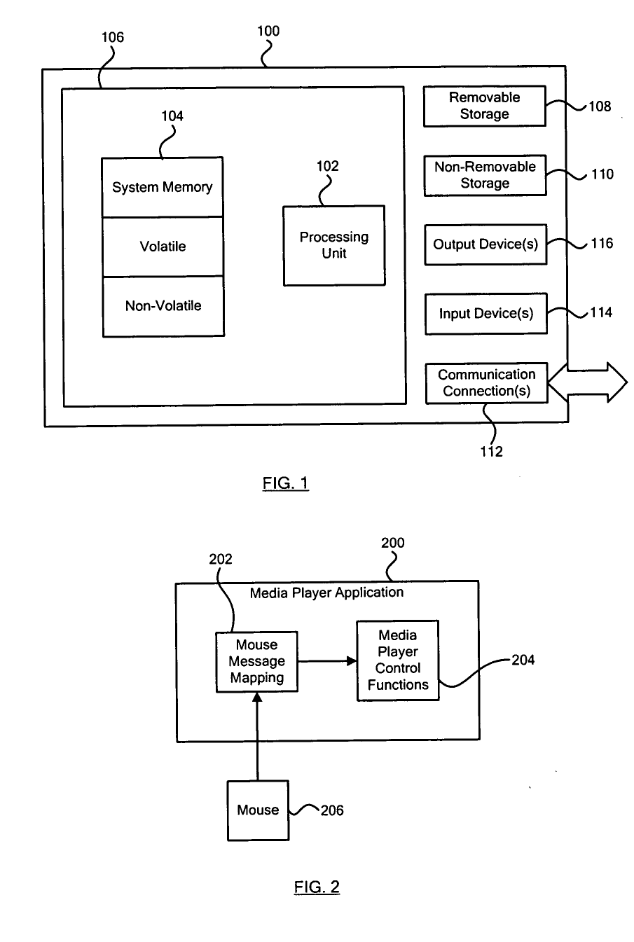

FIG. 1 is a simplified schematic representation of an example computer system 100 for implementing an example embodiment. Computer system 100 is only one example of a suitable operating environment and is not intended to suggest any limitation as to the scope of use or functionality of any practical embodiment. Other well known computing systems, environments, and/or configurations that may be suitable for use include, but are not limited to, personal computers, server computers, hand-held or laptop devices, personal digital assistants, mobile telephones, multiprocessor systems, microprocessor-based systems, programmable consumer electronics, network PCs, minicomputers, mainframe computers, distributed computing environments that include any of the above systems or devices, and the like.

Computer system 100 and certain aspects of the example embodiments may be described in the general context of computer-executable instructions, such as program modules, executed by one or more computers or other devices. Generally, program modules include routines, programs, objects, components, data structures, and/or other elements that perform particular tasks or implement particular abstract data types. Typically, the functionality of the program modules may be combined or distributed as desired in various embodiments.

Computer system 100 typically includes at least some form of computer readable media. Computer readable media can be any available media that can be accessed by computer system 100 and/or by applications executed by computer system 100. By way of example, and not limitation, computer readable media may comprise computer storage media and communication media. Computer storage media includes volatile, nonvolatile, removable, and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computer system 100. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

Referring again to FIG. 1, in its most basic configuration, computer system 100 typically includes at least one processing unit 102 and a suitable amount of memory 104. Depending on the exact configuration and type of computing system 100, memory 104 may be volatile (such as RAM), non-volatile (such as ROM, flash memory, etc.) or some combination of the two. This most basic configuration is identified in FIG. 1 by reference number 106. Additionally, computer system 100 may also have additional features/functionality. For example, computer system 100 may also include additional storage (removable and/or non-removable) including, but not limited to, magnetic or optical disks or tape. Such additional storage is illustrated in FIG. 1 by removable storage 108 and non-removable storage 110. Memory 104, removable storage 108, and non-removable storage 110 are all examples of computer storage media as defined above.

Computer system 100 may also contain communications connection(s) 112 that allow the system to communicate with other devices. Communications connection(s) 112 may be associated with the handling of communication media as defined above.

Computer system 100 may also include or communicate with input device(s) 114 such as a keyboard, mouse or other pointing device, pen, voice input device, touch input device, etc. In the example embodiment described below, input device(s) includes a standard pointing device (e.g., a mouse) that generates standard pointing device messages for processing by computer system 100 in connection with a media player control mode. Although the example embodiment described herein utilizes a mouse device, embodiments can be equivalently configured to support a trackball device, a joystick device, a touchpad device, or any type of general purpose pointing device. Computer system 100 may also include or communicate with output device(s) 116 such as a display, speakers, printer, or the like. All of these devices are well know in the art and need not be discussed at length here.

FIG. 2 is a simplified schematic representation of an example media player application 200 for implementing an example embodiment. Media player application 200 may be executed by any suitably configured computing device or system, for example, computer system 100. Media player application 200 is generally configured to support the playback of music CDs, DVD movies, electronic audio files, electronic video files, streaming audio files, streaming video files, or the like. Media player application 200 may be, for example, the WINDOWS MEDIA® player application, which is available from Microsoft Corporation. Of course, embodiments as described herein may be implemented in other products, applications, and systems. An embodiment of media player application 200 will include computer-readable instructions, logical components, and features for supporting conventional operation; such conventional aspects of media player application 200 will not be described in detail herein.

As depicted in FIG. 2, media player application 200 may include suitably configured logic that performs mouse message mapping 202. The mouse message mapping logic 202 may cooperate with suitably configured logic that is associated with media player control functions 204. In this example, media player application 200 is coupled to a general purpose mouse device 206 such that media player application 200 can receive standard mouse messages from mouse device 206. In example embodiments, mouse device 206 is a wireless device that transmits the standard mouse messages via any suitable wireless data communication technology (in alternate embodiments, mouse device 206 may be a wired/cabled device). The mouse messages may be processed by the operating system and/or by media player application 200. In the example embodiment, the mouse messages are processed by media player application 200. As used herein, a general purpose pointing device is one that need not be customized, modified, or specifically configured to support media player functions. A general purpose pointing device generates standard pointing device messages that can be interpreted in a conventional manner by the host computer system. In operation, media player application 200 can receive and process standard mouse messages from any general purpose mouse that is otherwise compatible with the host computer system. In other words, the mouse messages provided by general purpose mouse device 206 need not be modified or uniquely assigned to media player functions. In connection with example embodiments, a general purpose 2-button roller mouse device generates standard mouse messages in response to manipulation of its left button, right button, and roller click wheel, while a general purpose 4-button roller mouse device generates standard mouse messages in response to manipulation if its left button, right button, left thumb button, right thumb button, and roller click wheel.

Briefly, mouse message mapping logic 202 receives standard mouse messages from general purpose mouse device 206, and maps the standard mouse messages to corresponding media player control instructions. The converted media player control instructions can then be utilized as prompts for media player control function logic 204, which in turn carries out the corresponding media player control functions (e.g., play, stop, menu, rewind, or the like). Notably, in this example embodiment media player application 200 contains the intelligence and processing logic for interpreting the standard mouse messages and for converting the standard mouse messages into corresponding media player control functions. The processing of standard mouse messages in this manner is described in more detail below.

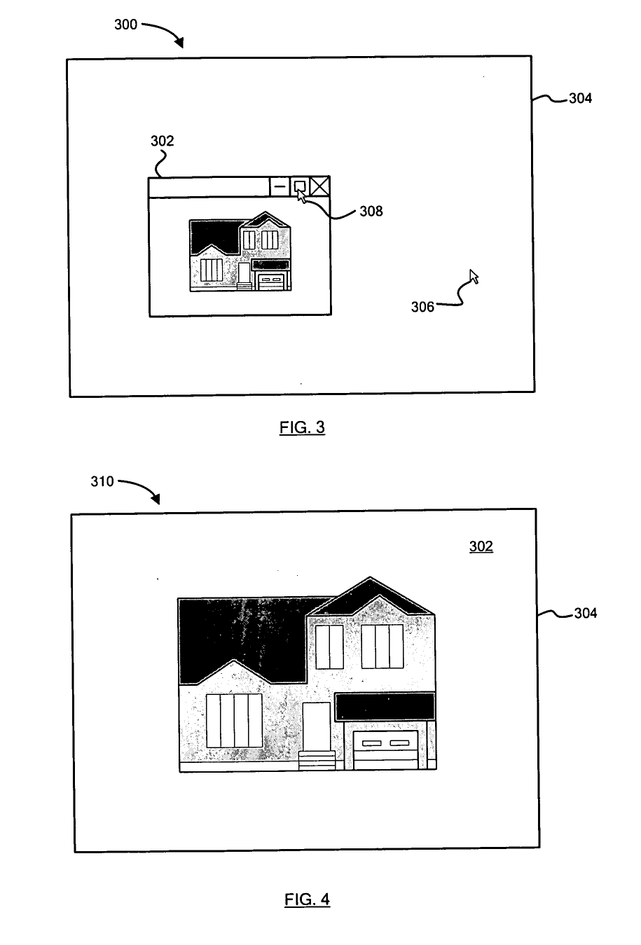

In example embodiments, the conversion of standard mouse messages into instructions specific to a media player application occurs when the media player application is in a full screen mode. In this regard, FIG. 3 is a simplified rendition of a screen shot 300 including a media player application 302 running in a non-full-screen mode. The perimeter of screen shot 300 represents the full screen viewing window 304 of the respective monitor or display element for the host system. As depicted in FIG. 3, media player application 302 is rendered on only a portion of the full screen viewing window 304. Under these conditions, mouse messages will control whatever application has focus of the cursor at the time. For example, mouse messages corresponding to a cursor position 306 will not influence operation of media player application 302. In contrast, mouse messages corresponding to a cursor position 308 might influence operation of media player application 302. In the illustrated scenario, a “left click” message for cursor 308 will represent a full screen request for media player application 302, and that request will enable the full screen mode for media player application 302.

FIG. 4 is a simplified rendition of a screen shot 310 including media player application 302 running in a full screen mode. As shown, media player application 302 consumes most (if not all) of the full screen viewing window 304. As described in more detail below, in response to the full screen mode media player application 302 enables a media player mouse control mode and initiates mouse capture such that mouse messages are diverted to media player application 302 by default. In response to the full screen mode, the computer system (via media player application 302) automatically repurposes the general purpose mouse device as a remote controller for media player application 302. This allows the mouse to function as a remote controller having media player specific functionality. Once repurposed in this manner, a wireless mouse can emulate the basic features of a handheld wireless remote controller.

In alternate embodiments, the computer system or the media player application 302 repurposes the general purpose pointing device as a remote controller for media player application 302 in response to certain operating conditions or status. For example, such repurposing may occur whenever the pointing device cursor is focused on the window corresponding to media player application 302. As another example, such repurposing may occur whenever the window corresponding to media player application 302 is displayed as the “top” window. As yet another example, such repurposing may occur whenever the window corresponding to media player application 302 is displayed at or above a predetermined window size, area, or dimension.

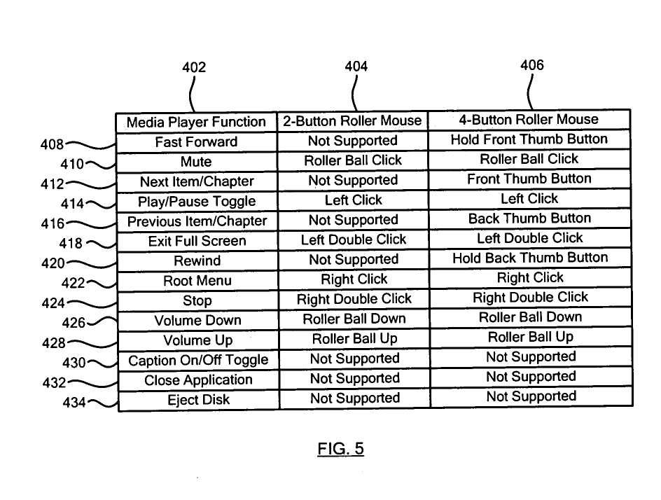

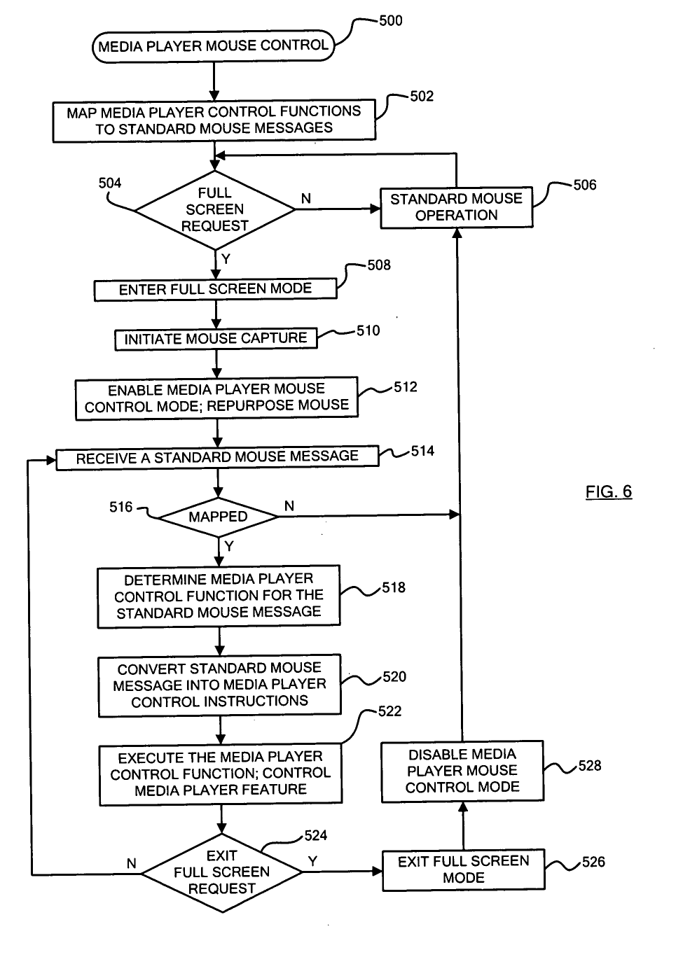

FIG. 5 is a table of example mapping of media player control functions to standard mouse messages. Referring to FIG. 2, such mapping may be associated with the functionality of mouse message mapping logic 202. The mapping shown in FIG. 5 is not intended to limit or otherwise restrict the scope of the example embodiments in any way; FIG. 5 simply depicts example mappings to assist in the description of practical embodiments. In particular, FIG. 5 includes a list of common media player functions 402 mapped to standard mouse messages for a general purpose 2-button roller mouse 404, and for a general purpose 4-button roller mouse 406. In practice, different mouse and pointing device configurations may support more messages, less messages, and/or alternate messages than that shown in FIG. 5.

In this example, media player functions 402 may include, without limitation: a fast forward function 408; a mute function 410; a next item/chapter function 412; a play/pause function 414; a previous item/chapter function 416; an exit full screen function 418; a rewind function 420; a menu function 422; a stop function 424; a volume adjust down function 426; a volume adjust up function 428; a caption on/off function 430; a close application function 432; and an eject disk function 434. Each of these functions may be mapped to a different standard mouse message (if supported), such that the media player application can distinguish the different mouse messages for purposes of function mapping. For example, the mute function 410 may be mapped to the standard mouse message corresponding to a roller ball click, and such functionality may be supported by both the 2-button roller mouse 404 and the 4-button roller mouse 406. As another example, the play/pause function 414 may be mapped to the standard mouse message corresponding to a left button click, and such functionality may be supported by both the 2-button roller mouse 404 and the 4-button roller mouse 406. In this example, however, the previous item/chapter function 416 is not supported by the 2-button roller mouse 404; the previous item/chapter function 416 may be mapped to the standard mouse message corresponding to a back thumb button click for the 4-button roller mouse 406. In this regard, the media player application will never receive a “back thumb button click” message from a 2-button roller mouse because such devices do not include a back thumb button. FIG. 5 indicates that the caption on/off function 430, the close a pplication function 432, and the eject disk function 434 may not be supported by the 2-button roller mouse 404 or the 4-button roller mouse 406. One or more of these three functions may, however, be supported by other standard pointing devices.

In one embodiment, the mapping of media player functions is written into the media player application itself and such mapping is not accessible to the user. In alternate embodiments, the mapping of media player control functions is user-configurable. For example, the user of the media player application may be able to customize the mapping of media player functions via a “preferences” or “options” menu in the media player application.

FIG. 6 is a flow diagram of a media player mouse control process 500 corresponding to an example embodiment. The various tasks performed in connection with process 500 may be performed by software, hardware, firmware, or any combination thereof. For illustrative purposes, the following description of process 500 may refer to elements mentioned above in connection with FIGS. 1-5. In example embodiments, portions of process 500 may be performed by different elements of the described system, e.g., the computer system, the media player application, the pointing device, or a combination thereof. It should be appreciated that process 500 may include any number of additional or alternative tasks, the tasks shown in FIG. 6 need not be performed in the illustrated order, and process 500 may be incorporated into a more comprehensive procedure or process having additional functionality not described in detail herein.

Media player mouse control process 500 may be performed by a media player application, by the operating system, and/or by any application or control of the host system. In this example, process 500 assumes that the media player application is running, whether or not any media is actually being played. Process 500 may begin by mapping media player control functions for the media player application to standard mouse messages (task 502). Task 502 may correspond to the maintenance of a mapping table, feature, or structure as described above in connection with FIG. 5. If process 500 receives a full screen request for the media player application (query task 504), then a task 508 may be performed. Otherwise, process 500 supports standard mouse operation (task 506) during which there is no behavioral change associated with the processing of standard mouse messages. As depicted in FIG. 5, task 506 may lead back to query task 504 such that process 500 can continue to monitor for a full screen request.

In response to a full screen request, media player mouse control process 500 may cause the media player application to enter the full screen mode (task 508), as described above in connection with FIG. 4. Also in response to a full screen request, process 500 may initiate mouse capture for the media player application (task 510). In this context, mouse capture results in the routing of all mouse messages to the media player application for processing. Also in response to a full screen request, process 500 may enable a media player mouse control mode (task 512), which automatically repurposes the general purpose mouse as a remote controller for the media player application. While in the media player mouse control mode, standard mouse messages are utilized to control the features, function, and operation of the media player application.

In this example, media player mouse control process 500 eventually receives at least one standard mouse message in response to user interaction with a general purpose mouse device (task 514). As explained above, standard mouse messages are generated in response to common mouse actions including, without limitation: left button click; right button click; left button double click; right button double click; roller ball click; roller ball scroll up/down; front thumb button click; back thumb button click; holding down front thumb button; and holding down back thumb button. In response to a standard mouse message, process 500 may check whether that standard mouse message is mapped to a media player control function or instruction (query task 516). If not, then process 500 may disregard the message or handle it according to standard mouse operation (task 506). If, however, the standard mouse message is mapped to a corresponding media player control function or instruction, then process 500 may proceed to a task 518.

In this example embodiment, media player mouse control process 500 may determine a media player control function corresponding to the standard mouse message (task 518). In practice, process 500 may cause the media player application to perform a table lookup procedure or to otherwise consult mapping assignments to resolve the particular media player function corresponding to the standard mouse message. Moreover, process 500 may convert the standard mouse message into a corresponding media player control instruction (or instructions) configured to control the operation of the media player application (task 520). In connection with task 520, process 500 may identify the desired media player function (e.g., mute, rewind, stop, volume adjust, etc.) and generate suitably configured control instructions that prompt the media player application to actually carry out the desired function. Consequently, process 500 may execute the designated media player control function (task 522) to control a corresponding feature of the media player application.

In practice, media player mouse control process 500 may continue indefinitely to facilitate operation in the media player mouse control mode. In this example, process 500 may monitor for an exit full screen request (query task 524), which may be initiated by the user, initiated automatically at the end of audio/video playback, or the like. Referring to FIG. 5, an exit full screen request may correspond to a designated standard mouse message that is mapped to an exit full screen function 418 for the media player application. An exit full screen request may also be generated if the media player application is closed, minimized, or switched to an inactive window, or if the viewing window for the media player application is reduced. If process 500 receives an exit full screen request, then a task 526 may be performed to exit the full screen mode for the media player application. As a result, the media player application may be closed, minimized, or reduced in size by the computer system. If, however, such a request is not received, then process 500 may be re-entered at task 514 such that another standard mouse message can be received and processed.

In response to the exit full screen request, media player mouse control process 500 may also disable the media player mouse control mode (task 528) such that standard mouse operation is re-established (task 506). In example embodiments, disabling of the media player mouse control mode occurs automatically in response to an exit full screen request, thus immediately releasing mouse capture for the media player application and returning mouse control to other applications that might be running on the computer system.

While at least one example embodiment has been presented in the foregoing detailed description, it should be appreciated that a vast number of variations exist. It should also be appreciated that the example embodiment or embodiments described herein are not intended to limit the scope, applicability, or configuration of the technology in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for controlling operation of a media player application, the method comprising:
receiving a standard pointing device message in response to user interaction with a general purpose pointing device;
determining a media player control function that is mapped to the standard pointing device message; and
executing the media player control function to control a corresponding feature of the media player application.

2. A method according to claim 1, further comprising enabling a media player pointing device control mode in response to a full screen request for the media player application.

3. A method according to claim 2, further comprising disabling the media player pointing device control mode in response to an exit full screen request for the media player application.

4. A method according to claim 3, wherein the exit full screen request corresponds to a designated standard pointing device message that is mapped to an exit full screen function for the media player application.

5. A method according to claim 1, further comprising initiating pointing device capture for the media player application.

6. A method according to claim 5, wherein initiating pointing device capture occurs in response to a full screen request for the media player application.

7. A method according to claim 1, further comprising:
mapping a mute function to a first standard message;
mapping a play/pause function to a second standard message;
mapping a menu access function to a third standard message;
mapping a stop function to a fourth standard message; and
mapping a volume adjust function to a fifth standard message.

8. A method according to claim 1, further comprising:
mapping a next item function to a first standard message;
mapping a previous item function to a second standard message;
mapping a rewind function to a third standard message; and
mapping a fast forward function to a fourth standard message.

9. A method according to claim 1, wherein a mapping of media player control functions is user-configurable.

10. A method for controlling operation of a media player application, the method comprising:
receiving a full screen request for the media player application;
in response to the full screen request, automatically repurposing a general purpose pointing device as a remote controller for the media player application;
in response to the full screen request, enabling a media player pointing device control mode; and
converting standard pointing device messages into corresponding media player control instructions.

11. A method according to claim 10, further comprising mapping media player control functions for the media player application to standard pointing device messages.

12. A method according to claim 11, wherein mapping media player control functions is user-configurable.

13. A method according to claim 11, further comprising:
receiving a standard pointing device message in response to user interaction with the general purpose pointing device;
converting the standard pointing device message into a corresponding media player control instruction; and
controlling, in response to the corresponding media player control instruction, a feature of the media player application.

14. A method according to claim 11, wherein mapping media player control functions comprises mapping an exit full screen function to a designated standard pointing device message.

15. A method according to claim 10, further comprising automatically disabling the media player pointing device control mode in response to an exit full screen request for the media player application.

16. A computer-readable medium having computer-executable instructions for performing steps comprising:
enabling a media player pointing device control mode for a media player application;
automatically repurposing a general purpose pointing device as a remote controller for the media player application;
receiving a standard pointing device message in response to user interaction with the general purpose pointing device; and
converting the standard pointing device message into a corresponding media player control function.

17. A computer-readable medium according to claim 16, further comprising computer-executable instructions for performing a step of receiving a full screen request for the media player application, wherein enabling the media player pointing device control mode is responsive to the full screen request.

18. A computer-readable medium according to claim 16, further comprising computer-executable instructions for performing a step of mapping media player control functions for the media player application to standard pointing device messages.

19. A computer-readable medium according to claim 16, further comprising computer-executable instructions for performing the step of controlling, in response to the corresponding media player control instruction, a feature of the media player application.

20. A computer-readable medium according to claim 16, further comprising computer-executable instructions for performing a step of disabling the media player pointing device control mode in response to an exit full screen request for the media player application, wherein the exit full screen request corresponds to a particular standard pointing device message that is mapped to an exit full screen function for the media player application.
